(19) United States
(12) Patent Application Publication
(10) Pub. No.: US 2010/0283215 A1
(43) Pub. Date: Nov. 11, 2010

(54) Clamping device for machine tools

(76) Inventor: Karl Hiestand, Pfullendorf (DE)

Correspondence Address: Scott R. Foster;Pandiscio & Pandiscio, P.C., 470 Totten Pond Road, Waltham, MA, 02451, US

(21) Appl. No.: 12/658,335

(22) Filed: Feb. 9, 2010

(30) Foreign Application Priority Data
Feb. 11, 2009 (EP) 09001874.8

(51) Int. Cl. B23B 31/26

(52) U.S. Cl. 279/125; 279/134

(57) ABSTRACT

A clamping device comprising clamping jaws actuated by means of an axially adjustable draw rod, the clamping device comprising a servomotor with a changeover function, a driveline arranged between the servomotor and the draw rod as well as a bell in a rotating mounting that is coupled to the servomotor, the driveline configured as a two-piece gear train, the first piece arranged in a housing permanently connected to a rotor shaft of the servomotor. An input element and output element of the gear train being connected to the bell by the second gear train.

A starter of the servomotor can be arranged in a fixed position and the rotor of the servomotor held stationary when a workpiece is clamped. The servomotor maintains a selected clamping force if the electrical power fails, and the clamping device is automatically secured.

### BACKGROUND OF THE INVENTION

1. Field of the Invention

The present invention relates to a clamping device for machine tools that is equipped with a power-operated chuck for holding a workpiece, the clamping jaws of which can be actuated using the clamping device by means of an axially moveable draw rod, in which the clamping device possesses a servomotor with a changeover function, a driveline located between the servomotor and the draw rod as well as a bell in a rotating mounting that is coupled to the servomotor in a driven connection, preferably on a hollow shaft connected to the machine spindle.

2. Description of the Invention

An electric clamping device of this kind is disclosed in DE 10 2006 050 918 A1. In this embodiment, the servomotor is coupled to a drive gear of a harmonic drive gear unit by means of the toothed belt drive and the gear unit is in a driven connection with the draw rod by means of a threaded roll drive. In this case, the harmonic drive gear unit converts the small torque to be generated by the servomotor at high rotation speeds into low rotation speeds with a high torque by means of its ratio.

Quite apart from the significant construction complexity occasioned by the harmonic drive gear unit, the fact that the drive gear of the harmonic drive gear unit is directly coupled with the servomotor means that it is necessary for the servomotor to have an appropriate direction of rotation as well as a precise rotation speed in relation to the machine spindle during a working procedure, so that a constant tensile or compressive force can be exerted on the clamping jaws by means of the draw rod. This in turn demands an external and very elaborate electronic machine control and monitoring system. This is because when the machine spindle is turning clockwise then the servomotor must rotate slightly faster than the spindle does. In anticlockwise rotation, on the other hand, it must rotate somewhat slower in order to transmit the corresponding torque onto the drive gear of the harmonic drive gear unit. These requirements are highly cost-intensive—also as far as maintenance is concerned—whilst commissioning and assembly of the clamping device thus disclosed are highly complicated. A further disadvantage concerns the problem that the moment of inertia of the servomotor is extremely difficult to control whilst maintaining the torque when there is a change of direction within a matter of seconds. What is more, in the event of a controller failure or a power outage then there is no guarantee of safe operation, with the result that the application range for this clamping device is highly restricted.

### SUMMARY OF THE INVENTION

The task of the present invention is therefore to create a clamping device for machine tools of the aforementioned type such that the stator of the servomotor can be located in a fixed position and that its rotor is stopped when a workpiece is clamped, so that there are no rotating masses whereas the torque required for the axial force to be exerted by the draw rod is available permanently all the same. In addition, the servomotor should maintain the selected clamping force even if there is a failure of the electrical power supply, with the effect that the clamping device is automatically secured. No complicated rotation speed and direction control unit should be required in order to achieve this. In spite of the straightforward construction involved, a high level of operating safety should be guaranteed at all times.

In accordance with the present invention, this is achieved in a clamping device for machine tools of the aforementioned type in that the driveline is configured as a two-part gear train, the first part of which is arranged in a housing that is permanently connected to the rotor shaft of the servomotor, that the input element and the output element of the first gear train are connected to the bell or to the machine spindle by means of the second gear train, and that different rotations relative to the input directions of rotation can be generated between the input element and the output element for the purpose of axial adjustment of the draw rod by means of the first gear train of the driveline on rotations of the housing.

In this case, it is highly advantageous for the two gear trains of the driveline to be to be configured alternately as a step-down gear unit and a step-up gear unit and for the ratios of the two gear trains in the driveline to be formed by a toothed belt drive, a V-belt drive or by gear ratios.

The servomotor can be configured as an electric motor, preferably as a brake armature motor, or as a hydraulic motor, and its standstill torque should act directly on the housing of the first gear train. In addition, the bell should be coupled through a gear unit drive or a roller circulating drive with the draw rod directly or via intermediate elements, in which case the bell should be in a driven connection with the drive element of the second gear train via a step-down gear unit in order generate high clamping forces.

Furthermore, it is advantageous for the clamping device to be provided with a safety to device by means of which the driveline can be automatically locked.

The safety device in this case can be formed from locking pins arranged on one of two components of the clamping device that can be rotated relative to one another and held against the force of a spring by an electromagnet, such that if the electrical power fails the locking pin automatically engages in an opening provided in the other component.

Furthermore, the clamping device should be equipped with a safety control unit by means of which the strength of individual or all components of the clamping device, in particular the gear trains, can be tested at selectable time intervals by means of a brief overload.

If a clamping device for machine tools is configured in accordance with the present invention, it is possible to generate the axial adjustment movements of the draw rod required for opening and closing the chuck by means of slight rotations of the servomotor and of the first gear train and/or the housing that accommodates it, and to transmit these in a straightforward manner via the second gear train, either directly or via the intermediary of additional gearing elements, onto the draw rod. The step-down or step-up ratio of the first gear train effects the relative rotation.

It is a further great advantage that, when a workpiece is clamped, a standstill torque from the servomotor acts on the chuck, with this torque being adjustable according to the desired or required clamping force and transmissible via the second gear train. It is therefore possible to use the clamping device configured in accordance with the present invention in a variety of applications, in spite of its straightforward design.

The servomotor of the clamping device, in particular when configured as a brake armature motor, represents a safety device because the clamping force is automatically maintained if there is a failure of the electrical energy, although a safety device for locking the driveline can also be provided in addition. Also, the clamping device can be equipped with a safety control unit in order to make it easy to check the components of the clamping device at selectable time intervals by means of an overload. Accordingly, an electric clamping device is created with a servomotor by means of which the clamping force can be selected and secured, and which only moves around slightly in one direction of rotation or another when the chuck is opened and closed. As a result, a high level of operational safety and a long service life are assured at all times.

### BRIEF DESCRIPTION OF THE DRAWINGS

The drawings show a sample embodiment and variants of the clamping device configured in accordance with the present invention, the details of which are explained below. In the drawings:

FIG. 1 shows the clamping device at rest, in an axial section,

FIG. 2 the clamping device in accordance with FIG. 1, with a clamped workpiece,

FIG. 3 a section through line III-III in FIG. 2,

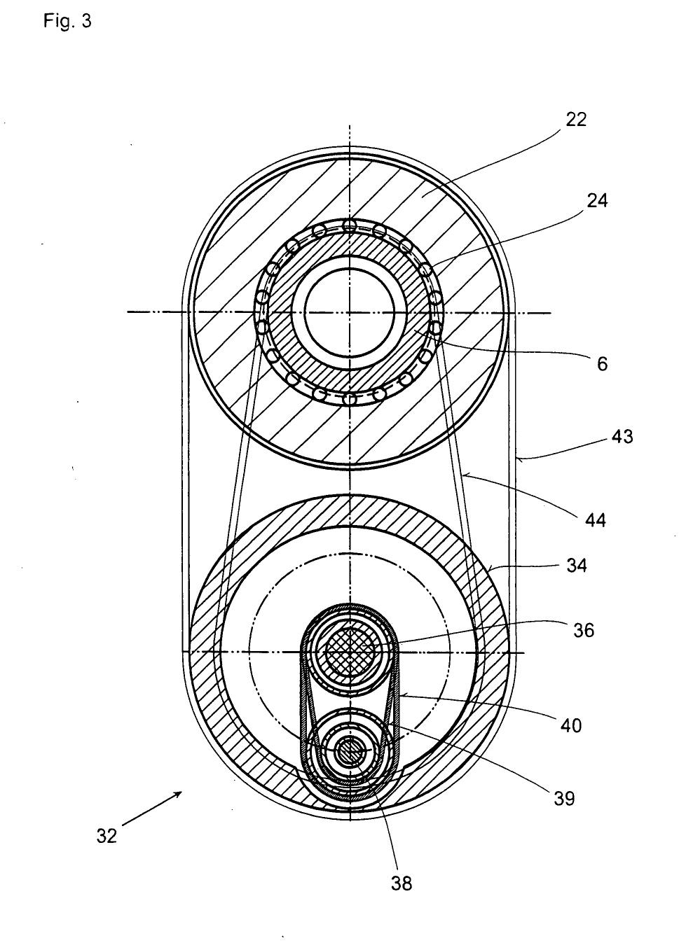

FIG. 4 the clamping device in accordance with FIG. 1, with an additional step-down gear unit,

FIG. 5 a section through line V-V in FIG. 4 and

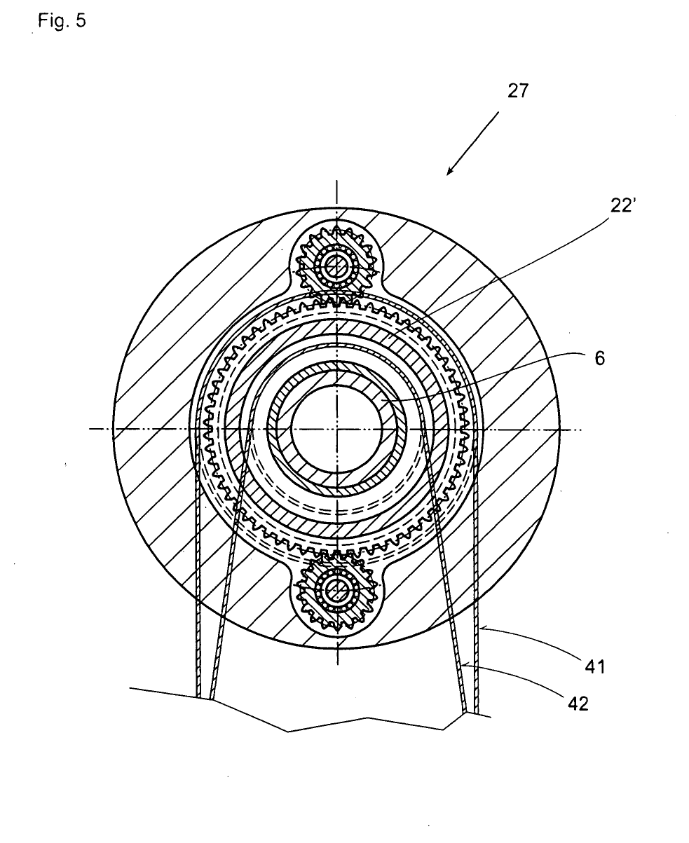

FIG. 6 the clamping device in accordance with FIG. 4 with a different embodiment of individual components and additional safety devices.

### DESCRIPTION OF THE PREFERRED EMBODIMENTS

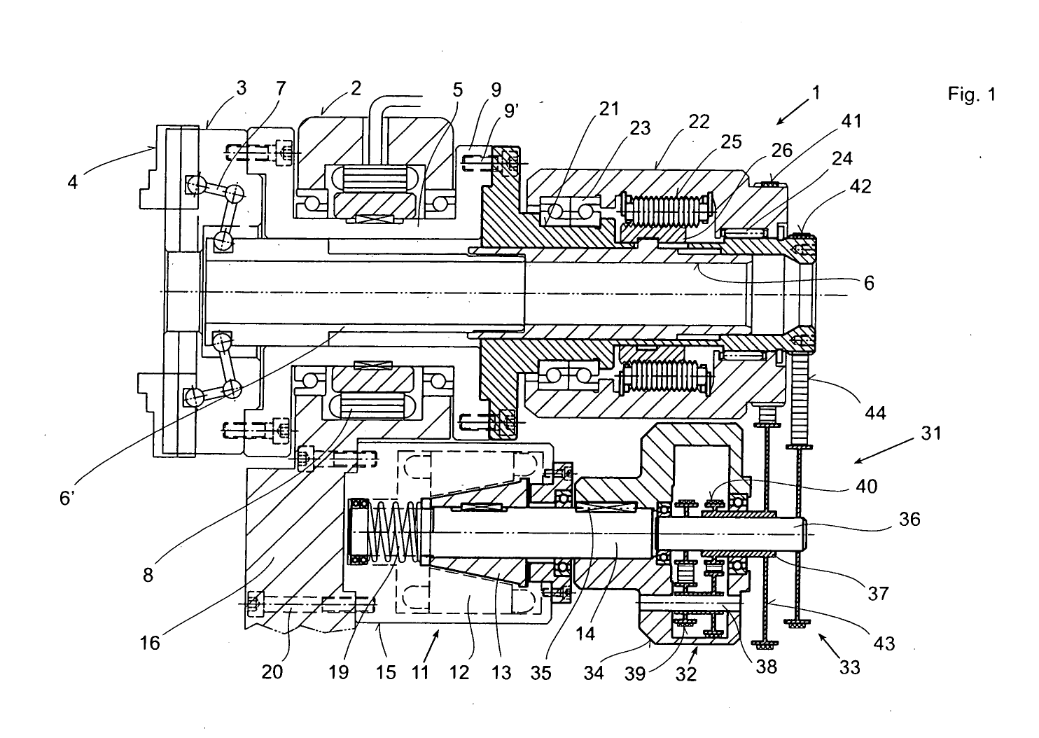

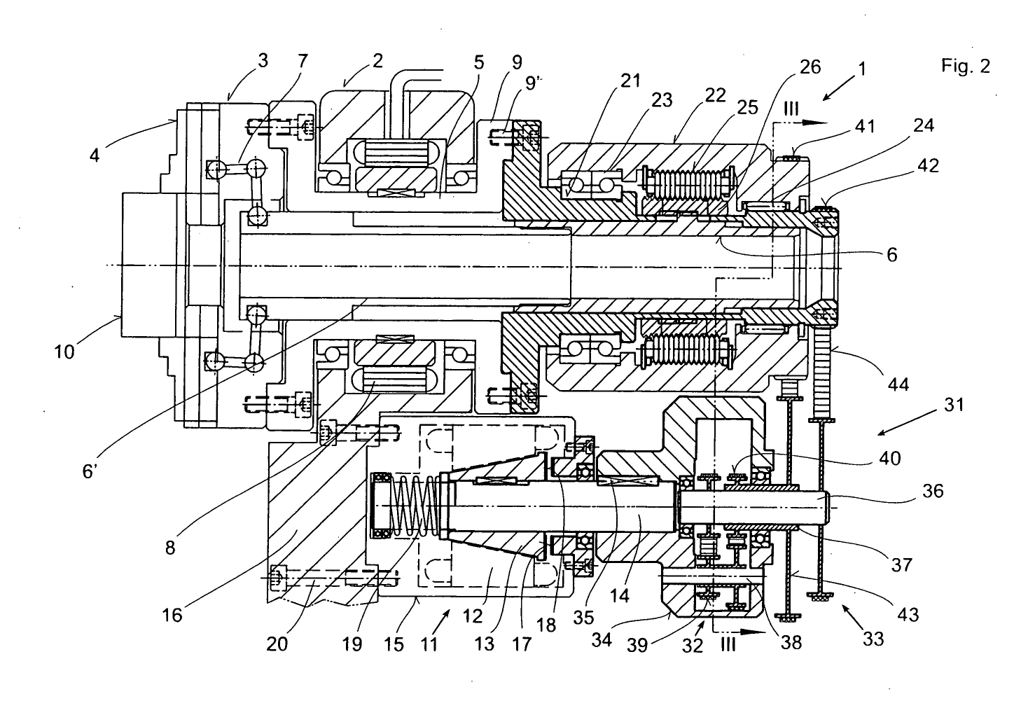

The clamping device illustrated in FIGS. 1 and 2 and identified by 1 is used for actuating a power-operated chuck 3 arranged on a machine tool 2, by means of the radially adjustable clamping jaws 4 of which a workpiece 10 to be machined can be clamped in the chuck 3. The clamping jaws 4 of the power-operated chuck 3 in this case can be actuated via relay levers 7 by an axially mobile draw rod 6 that is in a driven connection with an electric servomotor 11 that has a changeover function by means of a drivelines 31 and a bell 22. In this embodiment, the bell 22 is in a rotating mounting on a hollow shaft 21 by means of anti-friction bearings 23 and 24, with a bolt 9 firmly connecting the hollow shaft 21 to a machine spindle 5 that can be driven by an electric motor 8.

In the sample embodiment shown in FIGS. 1 and 2, the servomotor 11 of the clamping is device 1 is configured as a brake armature motor, a starter 12 of which is permanently arranged in a housing 15 that is held on a headstock 16 of the machine tool 2 by means of bolts 20. A rotor 13 of the servomotor, on the other hand, is provided with a rotor shaft 14 upon which a housing 34 prevented from rotating by means of a wedge 35 is placed. Furthermore, the rotor 13 is equipped with a brake disc 18 as well as a compression spring 19 which interact with a clutch disc 17 attached to the housing. In the event that the electrical power to the servomotor 11 fails, the force of the spring 19 will immediately press the rotor 13 with the brake disc 18 against the clutch disc 17 that is connected to the positionally fixed headstock 16 by means of the housing 15, thereby blocking the rotor shaft 14.

The driveline 31 provided between the servomotor 11 and the bell 22 is configured as a two-part driveline 32 and 33, the first part 32 of which is installed in the housing 34 that is permanently connected to the rotor shaft 14 of the servomotor 11 by means of the wedge 35. The drive energy of the servomotor 11 can therefore be transmitted onto the housing 34 and, via this, onto a first gear train 32.

The first gear train 32 has an input element 36 configured as a shaft which is connected to an output element 42 arranged on the driven hollow shaft 21 via a transmission ratio 44 of the second gear train 33, thereby establishing a driven connection to the hollow shaft 21. An output element 37 of the first gear train 32, on the other hand, is coupled to an input element 41 attached to the bell 22, and thereby coupled to the bell 22, via a transmission ratio 43. The first gear train 32 of the driveline 31 can therefore be driven by the machine spindle 5; also, the draw rod 6 can be influenced by this means.

Two transmission ratios 39 and 40 of the first gear train 32 are formed by toothed belt drives, the central toothed belt sheaves of which are arranged in a rotationally fixed mounting on the input element 36 or the output element 37. The toothed belt sheaves to that are matched with one another in each case are, on the other hand, able to rotate freely on a shaft 38 that is supported in the housing 34. If the housing 34 is driven by the rotor shaft 14 of the servomotor 11 then the shaft 38 is rotated about the input element 36, and a relative rotation of the first transmission ratio 39 in relation to the second transmission ratio 40 is generated in the first gear train 32, depending on the is ratio selected.

Both the transmission ratios 39 and 40 of the first gear train 32, as well as the transmission ratios 43 and 44 of the second gear train 33 can be configured as toothed belt drives or as V-belt drives, as shown in FIGS. 1 and 2. However, it is also possible for these transmission ratios to be configured as gear ratios (with gear wheels). Also, the ratios can be selected according to the application area of the clamping device 1.

FIGS. 1 and 2 show the clamping device 1 in different operating positions. FIG. 1 shows the clamping device 1 before the start of a clamping procedure, i.e. the chuck 3 is open, the servomotor 11 is de-energised with the effect that its clutch disc 17 is in contact with the brake disc 18 and all components are stationary. FIG. 2 shows a workpiece 10 clamped in between the clamping jaws 4 of the power-operated chuck 3.

In order, as shown in FIG. 2, to clamp a workpiece 10 in the open power-operated chuck 3 of the clamping device 1 shown in FIG. 1, it is necessary to move the clamping jaws 4 radially inwards. For this purpose, the draw rod 6 that is in a driven connection with the relay levers 7 by means of an intermediate element 6′ must be moved to the right. In order to accomplish this, it is necessary to generate a relative movement between the driven machine spindle 5 and the bell 22, which is done by means of the driveline 31, with the effect that the bell 22, which is coupled to the draw rod 6 by means of a gear unit drive and a driver 26, moves the draw rod 6 axially by a corresponding amount. Electrical power must be supplied to the servomotor 11 with voltage control for this purpose. The housing 15 connected to the rotor shaft 14 is thereby rotated with the effect that the transmission ratios 39 or 40 of the first gear train 32 or of the second gear train 33, depending on the configuration, create a differential rotation speed between the input element 36 and the output to element 37. The transmission ratio 43 of the second gear train 33 transmits the rotation speed differential in relation to the hollow shaft 21 onto the bell 22. The draw rod 6 is therefore pushed axially to the right. The direction of the servomotor 11 must be changed over in order to open the chuck 3, with the effect that the draw rod 6 is moved to the left.

To maintain the workpiece 10 in the clamped position within the chuck 3, it is necessary for the servomotor 11 to apply a corresponding torque in the operating position, the level of which torque must be selected in accordance with the required clamping force. This torque can easily be varied using a voltage regulator, therefore the clamping force of the chuck 3 can also be adapted to the particular application without difficulty. Also, the two gear trains 32 and 33 of the driveline 31 can be configured alternately as step-down or step-up gear units.

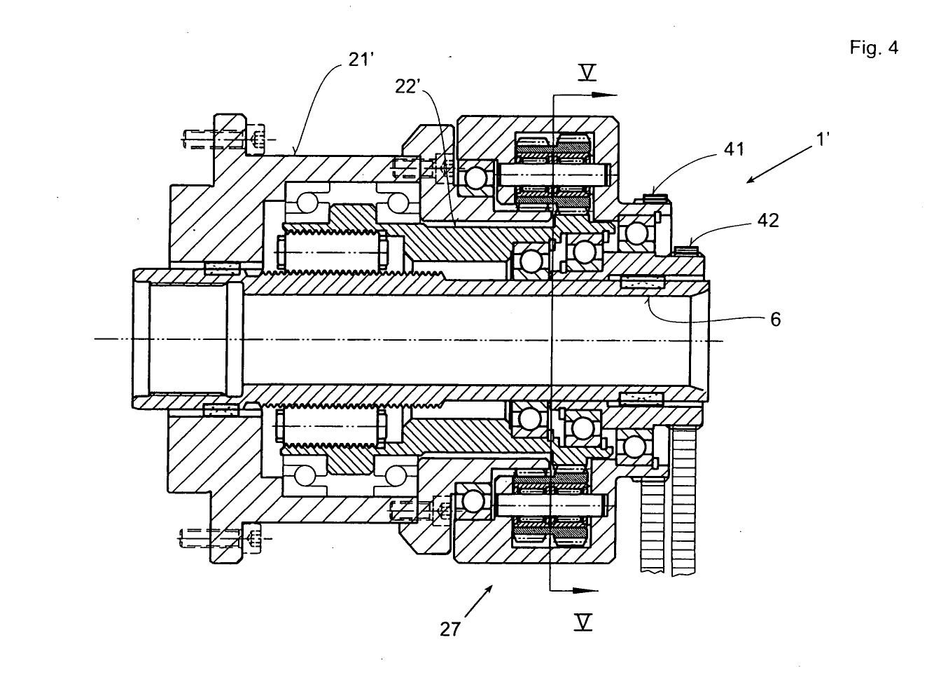

In the embodiment shown in FIG. 4, the bell 22′ has a step-down gear unit 27 positioned in front of it, with the effect that when there is a relative rotation between the hollow shaft 21′ and the draw rod 6, the latter is only moved by a small amount and, thus, particularly high clamping forces can be generated. The step-down gear unit 27 configured as a planetary gear unit in this case is in a driven connection with the machine spindle 5 and the input element 41 of the second transmission ratio, and in addition with the hollow shaft 21′.

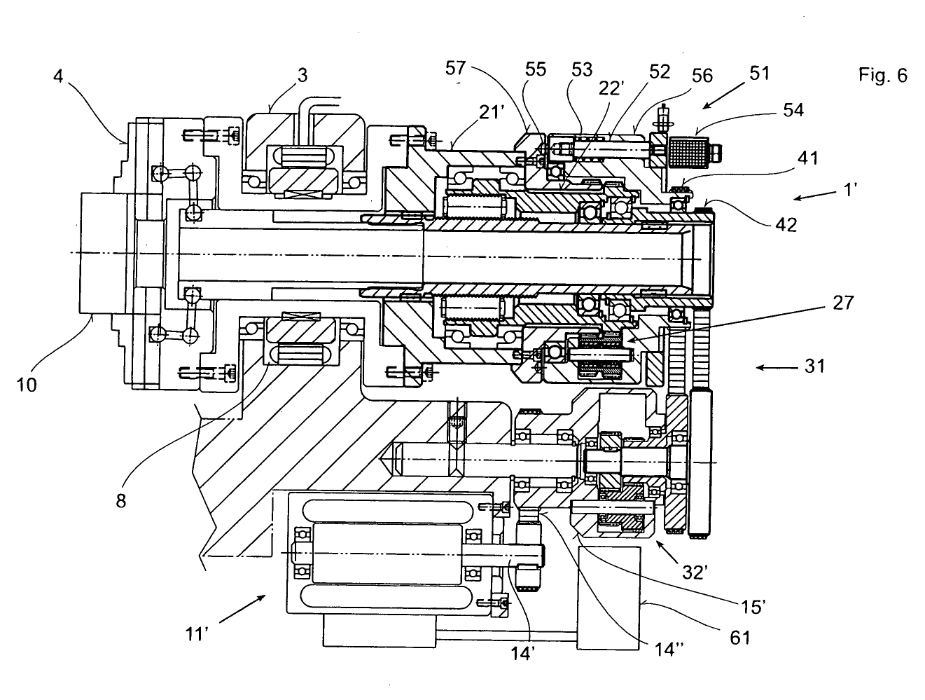

In accordance with FIG. 6, the clamping device 1′ is additionally equipped with a safety device 51 as well as a safety control unit 61. Furthermore, a commercially available electric motor is provided as the servomotor 11′ and a toothed belt drive 14″ provides a driven connected between its rotor shaft 14′ and the housing of the first gear train 32 which consists of gear ratios.

The safety device 51 in this case consists of a locking pin 52 inserted in an intermediate piece 56 connected to the input element 41 of the second gear train, of a spring 53 and of an electromagnet 54. In the event that the magnetic force fails, the force of the spring 53 causes the locking pin 52 to engage automatically in an opening 55 that is worked into another component 57 attached to the hollow shaft 21′. In this way, the clamping device 1′ is blocked with the effect that the clamping force is maintained, even if there is a power failure.

The safety control unit 61 enables the strength of individual or all components of the clamping device 1, and in particular the components of the gear trains 32 and 33, to be checked at selectable time intervals by means of overloading them for a short time. As a result, a high level of operational safety is guaranteed at all times.

1. A clamping device (1) for machine tools, the clamping device comprising a power-operated chuck (3) for holding a workpiece, clamping jaws (4) actuated by means of an axially moveable draw rod (6), the clamping device (1) further comprising a servomotor (11) with a changeover function, a driveline (31) located between said servomotor (11) and the draw rod (6), and a bell (22) in a rotating mounting coupled to said servomotor (11) by a driven connection, on a hollow shaft (21) connected to a machine spindle (5), wherein said driveline (31) comprises a two-part gear train (32, 33), a first part (32) thereof being arranged in a housing (34) permanently connected to a rotor shaft (14) of said servomotor (11), such that an input element (36) and an output element (37) of said first gear train (32) are connected to a selected one of said bell (22) and the machine spindle (5) by means of said second gear train (33), and that different rotations relative to input directions of rotation can be generated between the input element (36) and the output element (37) for the purpose of axial adjustment of the draw rod (6) by means of said first gear train (32) of said driveline (31) on rotations of the housing (34).

2. The clamping device in accordance with claim 1, wherein said gear trains (32, 33) of said driveline (31) are configured alternately as a step-down gear unit and a step-up gear unit.

3. The clamping device in accordance with claim 2, wherein ratios (39, 40) of said gear trains (32, 33) in said driveline (31) are formed by a selected one of a toothed belt drive, a V-belt drive, and gear ratios.

4. The clamping device in accordance with claim 1, wherein said servomotor (11) comprises a selected one of a brake armature motor and a hydraulic motor, and standstill torque thereof acts directly on the housing (34) of said first gear train (32).

5. The clamping device in accordance with claim 1, wherein said bell (22) is coupled through a selected one of a gear unit drive (25) and a roller circulating drive with the draw rod (6).

6. The clamping device in accordance with claim 5, wherein said bell (22′) is in a driven connection with a drive element (43) of said second gear train (33) via a step-down gear unit.

7. The clamping device in accordance with claim 1, wherein the clamping device (1) is provided with a safety device (51) by means of which the said driveline (31) can be automatically locked.

8. The clamping device in accordance with claim 7, wherein the safety device (51) is formed from locking pins (52) arranged on one of first and second components of the clamping device (1), the components being adapted to be rotated relative to one another and held against the force of a spring (53) by an electromagnet (54), such that if the magnetic power fails, a locking pin (52) of one component automatically engages in an opening (55) in the other component.

9. The clamping device in accordance with claim 1, wherein the clamping device (1) is provided with a safety control unit (61) by means of which the strength of components of the clamping device (1), including the gear trains, can be tested at selectable time intervals by means of a brief overload.
